(19) United States
(12) Patent Application Publication
(10) Pub. No.: US 2026/0266735 A1
(43) Pub. Date: Sep. 10, 2026

(54) APPARATUS FOR TIRE SCANNING AND METHODS OF USING SAME

(71) Applicant: 3DM Devices Inc., Aldergrove (CA)

(72) Inventor: John Howard KEIGHTLEY, Abbotsford (CA)

(21) Appl. No.: 19/460,279

(22) Filed: Jan. 26, 2026

Related U.S. Application Data
(63) Continuation of application No. PCT/CA2024/050973, filed on Jul. 23, 2024.
(60) Provisional application No. 63/516,451, filed on Jul. 28, 2023.

(51) Int. Cl. G01N 21/88; G01N 21/95; G01N 21/954

(52) U.S. Cl. CPC G01N 21/8806; G01N 21/9515; G01N 21/954; G01N 2201/06113

(57) ABSTRACT

A tire scanning apparatus comprising a body, one or more tire support features attached to the body for supporting a tire in a substantially upright orientation for rotation substantially in place about a rolling axis of the tire, a plurality of outer sensors attached to the body to capture outer surface geometry data corresponding to an intersection of an imaging plane and an outer surface of a portion of the tire and an optional inner sensor head moveably connected to the body. The inner sensor head is positionable within a cavity defined by an inner surface of the tire to capture inner surface geometry data corresponding to an intersection of the imaging plane and an inner surface of the portion of the tire.

### REFERENCE TO RELATED APPLICATIONS

This application is a continuation of Patent Cooperation Treaty (PCT) application No. PCT/CA 2024/050973 which has an international filing date of 23 Jul. 2024 and which in turn claims priority from, and for the purposes of the United States of America the benefit under 35 USC § 119 in relation to, U.S. application No. 63/516451 filed 28 Jul. 2023. All of the applications referred to in this paragraph are hereby incorporated herein by reference.

### TECHNICAL FIELD

This invention relates to the field of tire inspection and in particular to apparatus and methods for scanning of tires such as automotive tires and tires for other vehicles, trailers and/or the like.

### BACKGROUND

A single factory may output thousands or tens of thousands of tires per day. Due to the potentially catastrophic nature of a tire failure, it is desirable to inspect every tire produced for flaws. Such flaws may include undesirable bulges, bumps, lumps, cracks, thin sections, inclusions, holes, gaps, seams, cuts, etc.

Historically, inspection of tires is done manually. Due to the large number of tires produced, significant expense is incurred employing people to inspect tires. Furthermore, due at least in part to the limited time allowed for inspection of each tire, it is not uncommon for a manual inspection to miss one or more flaws in a tire.

Various apparatus have been proposed for automated or semi-automated inspection of tires. Most such systems place a tire on its side such that it must be flipped over for the other side to be inspected thereby necessitating human intervention, complex tire flipping machinery, relatively large amounts of floor space and/or additional inspection time.

There is a general desire for improved apparatus and methods for tire inspection which reduce human intervention, floor space usage and/or inspection time and/or which do not rely on manual tire flipping or complex tire flipping machinery.

The foregoing examples of the related art and limitations related thereto are intended to be illustrative and not exclusive. Other limitations of the related art will become apparent to those of skill in the art upon a reading of the specification and a study of the drawings.

### SUMMARY

The following embodiments and aspects thereof are described and illustrated in conjunction with systems, tools and methods which are meant to be exemplary and illustrative, not limiting in scope. In various embodiments, one or more of the above-described problems have been reduced or eliminated, while other embodiments are directed to other improvements.

One aspect of the invention provides a tire scanning apparatus. The tire scanning apparatus may comprise a body, one or more tire support features attached to the body for supporting a tire in a substantially upright orientation for rotation substantially in place about a rolling axis of the tire, a plurality of outer sensors attached to the body to capture outer surface geometry data corresponding to an intersection of an imaging plane and an outer surface of a portion of the tire.

In some embodiments, the tire scanning apparatus comprises an inner sensor head moveably connected to the body, the inner sensor head positionable within a cavity defined by an inner surface of the tire to capture inner surface geometry data corresponding to an intersection of the imaging plane and an inner surface of the portion of the tire.

In some embodiments, the portion of the tire is a lower portion of the tire.

In some embodiments, the plurality of outer sensors comprises one or more first outer sensors directed to a first outer sidewall surface of the tire. In some embodiments, the plurality of outer sensors comprises one or more second outer sensors directed to a second outer sidewall surface of the tire. In some embodiments, the plurality of outer sensors comprises one or more third outer sensors directed to an outer tread surface of the tire. In some embodiments, the plurality of outer sensors are arranged in pairs of outer sensors and each pair of outer sensors comprises a first sensor of the pair of outer sensors on a first side of the imaging plane and a second sensor of the pair of outer sensors on a second side of the imaging plane.

In some embodiments, for each pair of outer sensors, an orientation of the first sensor of the pair of outer sensors is mirror symmetric about the imaging plane to an orientation of the second sensor of the pair of outer sensors. In some embodiments, for each pair of outer sensors, a location of the first sensor of the pair of outer sensors is mirror symmetric about the imaging plane to a location of the second sensor of the pair of outer sensors.

In some embodiments, a combined field of view of the plurality of outer sensors captures the entirety of the intersection of the imaging plane with the outer surface of the portion of the tire. In some embodiments, a combined field of view of the plurality of inner sensors captures the entirety of the intersection of the imaging plane with the inner surface of the portion of the tire.

In some embodiments, the tire scanning apparatus comprises one or more outer light sources arranged to project light substantially co-planar to the imaging plane and onto the outer surface of the portion of the tire. In some embodiments, the one or more outer light sources comprise one or more outer laser projectors. In some embodiments, the one or more outer light sources comprise one or more planar laser projectors oriented to project laser light substantially co-planar with the imaging plane.

In some embodiments, the plurality of inner sensors comprises one or more first inner sensors directed to a first inner sidewall surface of the tire. In some embodiments, the plurality of inner sensors comprises one or more second inner sensors directed to a second inner sidewall surface of the tire. In some embodiments, the plurality of inner sensors comprises one or more third inner sensors directed to an inner tread surface of the tire.

In some embodiments, the plurality of inner sensors comprises one or more first inner sensors directed to a first inner sidewall surface of the tire, the plurality of inner sensors comprises one or more second inner sensors directed to a second inner sidewall surface of the tire and the one or more first inner sensors are located on a first side of the imaging plane and the one or more second inner sensors are located on a second side of the imaging plane.

In some embodiments, the plurality of inner sensors comprises one or more third inner sensors directed to an inner tread surface of the tire and one of the one or more third inner sensors is located on a first side of the imaging plane and another one of the one or more third inner sensors is located on a second side of the imaging plane.

In some embodiments, the plurality of inner sensors comprises a first inner sensor directed to a first inner sidewall surface of the tire, the plurality of inner sensors comprises a second inner directed to a second inner sidewall surface of the tire and the plurality of inner sensors comprises two third inner sensors directed to an inner tread surface of the tire.

In some embodiments, the tire scanning apparatus comprises one or more inner light sources arranged to project light onto the intersection of the imaging plane and the inner surface of the portion of the tire. In some embodiments, the one more inner light sources comprise one or more inner laser projectors. In some embodiments, the one more inner light sources comprise one or more inner planar laser projectors oriented to project laser light substantially co-planar with the imaging plane.

In some embodiments, the tire support features comprise two or more lower rollers for rotatably supporting the tire in the substantially upright orientation. In some embodiments, the tire support features comprise a bias roller biasable down against the tire to keep the tire substantially in place. In some embodiments, the bias roller comprises a plurality of annular rings threaded onto a rod such that the bias roller can accommodate inconsistencies in the shape of the tire. In some embodiments, the tire scanning apparatus comprises a biasing element biasing the bias roller against the tire. In some embodiments, the biasing element comprising one of a spring, an elastomeric component and an actuator.

In some embodiments, the tire scanning apparatus comprises a belt supported by the two lower rollers wherein the tire is rotatably supported in the substantially upright orientation on the belt.

In some embodiments, the inner sensor head is retractable to allow for insertion and removal of the tire from the tire scanning apparatus. In some embodiments, the tire scanning apparatus comprises an arm attached to the body, the arm actuatable to retract the inner sensor head to allow for insertion and removal of the tire from the tire scanning apparatus.

In some embodiments, the rolling axis is generally horizontal. In some embodiments, an angle formed between the rolling axis and a horizontal is less than 10° or less than 5° or less than 2.5°.

Another aspect of the invention provides a method of tire scanning. The method may comprise supporting a tire in a substantially upright orientation for rotation substantially in place about a rolling axis of the tire, capturing first outer surface geometry data corresponding to an intersection of an imaging plane and an outer surface of a first radial slice of the tire, positioning an inner sensor head within a cavity defined by an inner surface of the tire, capturing first inner surface geometry data corresponding to an intersection of the imaging plane and an inner surface of the first radial slice of the tire, rotating the tire about the rolling axis of the tire, capturing second outer surface geometry data corresponding to an intersection of the imaging plane and an outer surface of a second radial slice of the tire and capturing second inner surface geometry data corresponding to an intersection of the imaging plane and an inner surface of the second radial slice of the tire.

In some embodiments, capturing the first outer surface geometry data and the first inner surface geometry data occurs substantially simultaneously. In some embodiments, capturing the second outer surface geometry data and the second inner surface geometry data occurs substantially simultaneously.

In some embodiments, the method comprises rotating the tire about the rolling axis of the tire continuously while capturing the first outer surface geometry data, the first inner surface geometry data, the second outer surface geometry data and the second inner surface geometry data.

In some embodiments, capturing first outer surface geometry data at the intersection of the imaging plane and the outer surface of the first radial slice of the tire comprises projecting light substantially co-planar to the imaging plane onto the intersection of the imaging plane and the outer surface of the first radial slice of the tire.

In some embodiments, capturing first inner surface geometry data at the intersection of the imaging plane and the inner surface of the first radial slice of the tire comprises projecting light substantially co-planar to the imaging plane onto the intersection of the imaging plane and the inner surface of the first radial slice of the tire.

In some embodiments, the method comprises outputting a three-dimensional model of the tire based at least in part on the first outer surface geometry data, the first inner surface geometry data, the second outer surface geometry data and the second inner surface geometry data.

In some embodiments, the rolling axis is generally horizontal. In some embodiments, an angle formed between the rolling axis and a horizontal is less than 10° or less than 5° or less than 2.5°.

In addition to the exemplary aspects and embodiments described above, further aspects and embodiments will become apparent by reference to the drawings and by study of the following detailed descriptions.

### BRIEF DESCRIPTION OF THE DRAWINGS

Exemplary embodiments are illustrated in referenced figures of the drawings. It is intended that the embodiments and figures disclosed herein are to be considered illustrative rather than restrictive.

FIG. 1A is a schematic side view of a tire. FIG. 1B is a schematic front cross-section of a slice of a tire taken along line A-A.

FIG. 2 depicts a tire scanning apparatus according to an exemplary embodiment of the invention.

FIG. 3A is a schematic side view of tire support features according to an exemplary embodiment of the invention. FIG. 3B is a schematic side view of tire support features according to another exemplary embodiment of the invention. FIG. 3C is a schematic side view of tire support features according to another exemplary embodiment of the invention.

FIG. 4 is a schematic front view of a portion of sensing system of a tire scanning apparatus according to an exemplary embodiment of the invention.

FIG. 5 is another schematic front view of a portion of the sensing system of FIG. 4.

FIG. 6 is a schematic top view of a portion of the sensing system of FIG. 4.

FIG. 7 is another schematic top view of a portion of the sensing system of FIG. 4.

FIG. 8 depicts a portion of a sensing system of a tire scanning apparatus according to an exemplary embodiment of the invention.

FIG. 9 is a schematic bottom view of a portion of the sensing system of FIG. 4.

FIG. 10 is another schematic bottom view of a portion of the sensing system of FIG. 4.

FIG. 11 is a schematic front view of a portion of the sensing system of FIG. 4.

FIG. 12A is a bottom view of a portion of a sensing system of a tire scanning apparatus according to an exemplary embodiment of the invention. FIG. 12B is an isometric view of a portion of the sensing system of the tire scanning apparatus of FIG. 12A. FIG. 12C is a side view of a portion of the sensing system of the tire scanning apparatus of FIG. 12A.

FIG. 13 is a flowchart of a method for tire scanning according to an exemplary embodiment of the invention.

FIG. 14A depicts a tire scanning apparatus having an adjustable arm in a first position according to an exemplary embodiment of the invention. FIG. 14B depicts the tire scanning apparatus of FIG. 14B wherein the adjustable arm is in a second position according to an exemplary embodiment of the invention. FIG. 14C depicts a partial cutaway view of the tire scanning apparatus of FIG. 14B.

### Description

Throughout the following description specific details are set forth in order to provide a more thorough understanding to persons skilled in the art. However, well known elements may not have been shown or described in detail to avoid unnecessarily obscuring the disclosure. Accordingly, the description and drawings are to be regarded in an illustrative, rather than a restrictive, sense.

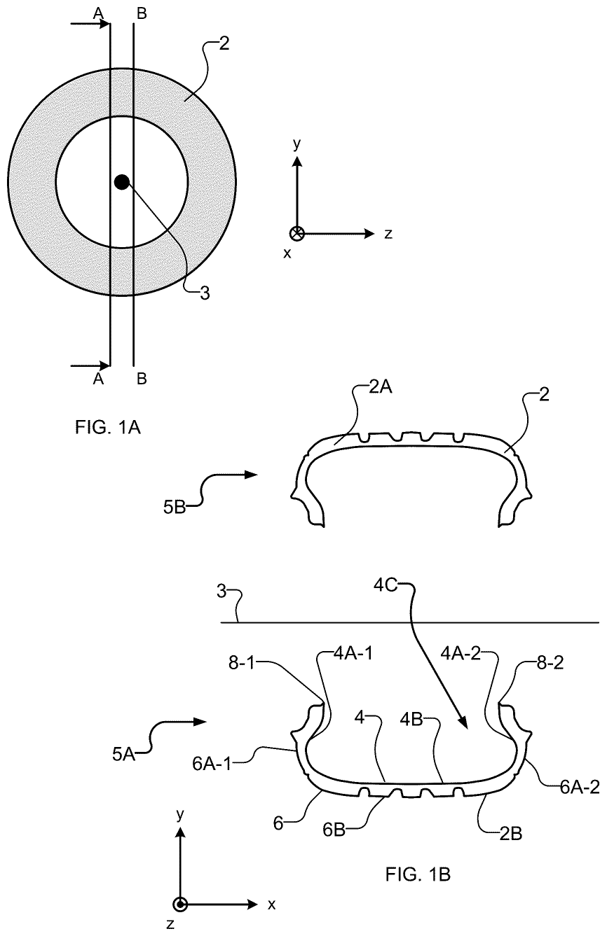

FIG. 1A is a schematic depiction of the side of a tire 2 in an upright orientation. FIG. 1B is a schematic depiction of an XY plane cross-section of the front of tire 2 from line A-A (as shown in FIG. 1A). For ease of illustration, the FIG. 1B schematic cross-section only shows the portion of tire 2 between line A-A and line B-B (as shown in FIG. 1A).

Tire 2 has a rolling axis 3 about which it rotates when mounted on a wheel of a vehicle. For convenience, rolling axis 3 is depicted throughout the present drawings as being oriented in the x-direction when tire 2 is upright but this is not mandatory.

Tire 2 has an inner surface 4 extending or spanning from a first bead 8-1 of tire 2 to a second bead 8-2 of tire 2 and an outer surface 6 extending or spanning from first bead 8-1 to second bead 8-2. Inner surface 4 includes a first inner sidewall surface 4A-1, a second inner sidewall surface 4A-2 and an inner tread surface 4B. Outer surface 6 includes a first outer sidewall surface 6A-1, a second outer sidewall surface 6A-2 and an outer tread surface 6B.

When oriented in an upright orientation (e.g. such that tire 2 can roll about rolling axis 3 and rolling axis 3 is generally horizontal), at a given instant, tire 2 has an upper portion 2A above rolling axis 3 and a lower portion 2B below rolling axis 3. As tire 2 rolls, parts of tire 2 that were once part of lower portion 2A become part of upper portion 2B and vice versa. As such, the terms upper portion 2A and lower portion 2B refer to portions of tire 2 at a particular instant in time. Rolling axis may be considered to be generally horizontal when an angle formed between rolling axis and the horizontal is less than 10° and, in some embodiments, less than 5° and, in some embodiments, less than 2.5°.

Tire 2 may be notionally divided into radial slices 5. For ease of description, the term “cross-sectional shape” should be understood to refer to the shape of the perimeter of the XY plane section of a particular radial slice 5 of tire 2 at a given instant. For example, FIG. 1B depicts the cross-sectional shape of a radial slice 5A of tire 2 where radial slice 5A is the radial slice 5 of tire 2 located at 6 o'clock on tire 2 at a given instant. FIG. 1B also depicts the cross-sectional shape of a radial slice 5B where radial slice 5B is the radial slice 5 of tire 2 located at 12 o'clock on tire 2 at a given instant.

One aspect of the invention provides an apparatus for tire scanning. The apparatus may support tire 2 in an upright orientation (e.g. where rolling axis 3 is generally horizontal) and comprises one or more sensors employable to determine one or more aspects of the geometry of inner surface 4 and/or outer surface 6 of tire 2 as tire 2 is rotated substantially in place about its rolling axis 3. The output of the tire scanning apparatus may be employed to create a 3D model of tire 2 which may be used to automatically or manually inspect tire 2.

One aspect of the invention comprises a method of tire scanning comprising determining one or more aspects of the geometry of inner surface 4 and outer surface 6 of tire 2 by obtaining the cross-sectional shape of a first radial slice 5 of tire 2, then rotating tire 2 in a substantially upright about its rolling axis 3 (e.g. where rolling axis 3 is generally horizontal) and obtaining the cross-sectional shape of a second radial slice 5 of tire 2. This may be repeated, for example, until at least a full rotation of tire 2 about axis 3 is completed and the cross-sectional shapes of a plurality of radial slices 5 are obtained. The resultant cross-sectional shape data can then be combined by suitable processing of the cross-sectional shapes (e.g. stitching, smoothing, interpolation, etc.) to obtain a complete geometry of inner surface 4 and outer surface 6 of tire 2 which can then be employed to automatically or manually inspect tire 2.

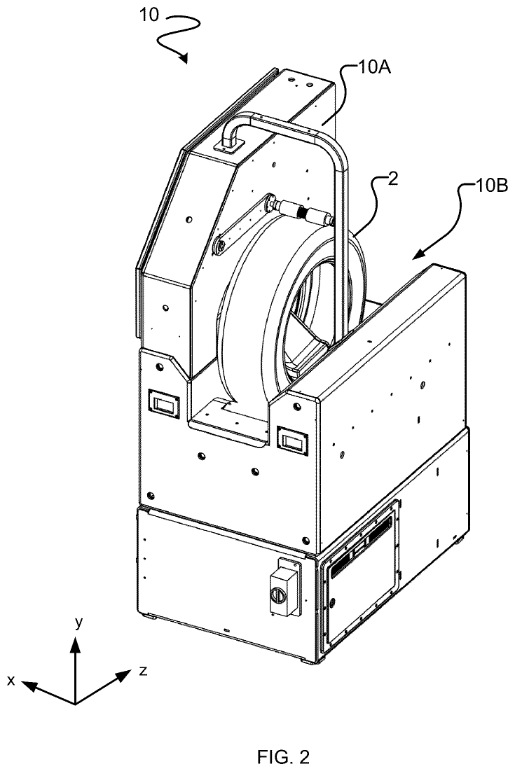

FIG. 2 depicts a tire scanning apparatus 10 (which, for brevity, may be referred to herein as apparatus 10). Apparatus 10 receives a tire 2 at least partially within a space 10B defined by a body 10A of apparatus 10. Space 10B may be open at one or both z-direction ends to facilitate insertion and removal of tire 2 from space 10B (e.g. to allow tire 2 to be rolled into or out of space 10B).

Apparatus 10 supports tire 2 in a substantially upright orientation (e.g. where rolling axis 3 is generally horizontal). Apparatus 10 may be configured to cause tire 2 to rotate substantially in place about its rolling axis 3 in a substantially upright orientation. When it is described that tire 2 rotates substantially in place about its rolling axis 3 in a substantially upright orientation, the mass of tire 2 may be substantially supported on tread surface 6B during rotation of tire 2 about its rolling axis 3 rather than sidewalls 6A-1 or 6A-2 of tire 2 (as would be the case where tire 2 is lying on its side). While tire 2 rotates substantially in place about its rolling axis 3, the orientation and/or position of rolling axis 3 and tire 2 may not be perfectly constant. For example, an orientation of rolling axis 3 may move about any of an x-direction axis, a y-direction axis and a z-direction axis (e.g. by up to 10°, by up to 20°, by up to 30° or by up to 40°), the position of rolling axis 3 relative to apparatus 10 may vary in the y-direction or the z-direction, and a position of a YZ midplane of tire 2 relative to apparatus 10 may vary in the x-direction and/or in the direction of rolling axis 3. It should also be understood that while tire 2 rotates substantially in place about its rolling axis 3, tire 2 may deform (e.g. wander, wobble, etc.) due to the forces of gravity and/or the inherent flexibility/deformability of tire 2. Movement and deformation of tire 2 may be limited, at least in part, by one or more of support features 12 (discussed in more detail below) and body 10A. While apparatus 10 can accommodate some changes in orientation or position of axis 3 and/or tire 2, in some embodiments, it may be desirable to manually or automatically position tire 2 in space 10B of apparatus 10 so that rolling axis 3 is positioned within suitable tolerances.

Apparatus 10 may comprise one or more tire support features 12 connected to body 10A to support tire 2 in a substantially upright orientation (with a generally horizontal rolling axis 3) and/or allow tire 2 to rotate in place about its rolling axis 3. Tire support features 12 may comprise any suitable elements to support tire 2 in a substantially upright orientation and to allow tire 2 to rotate in place about its rolling axis 3. Tire support features 12 may support tire 2 substantially on tread surface 6B but this is not mandatory and tire support features may also or alternatively support tire 2 by first bead 8-1, second bead 8-2 and/or inner tread surface 4B. Support features 12 may comprise one or more rollers, belts, wheels, bearings, bearing surfaces, etc. to support tire 2 in a substantially upright orientation and/or allow tire 2 to rotate in place about its rolling axis 3.

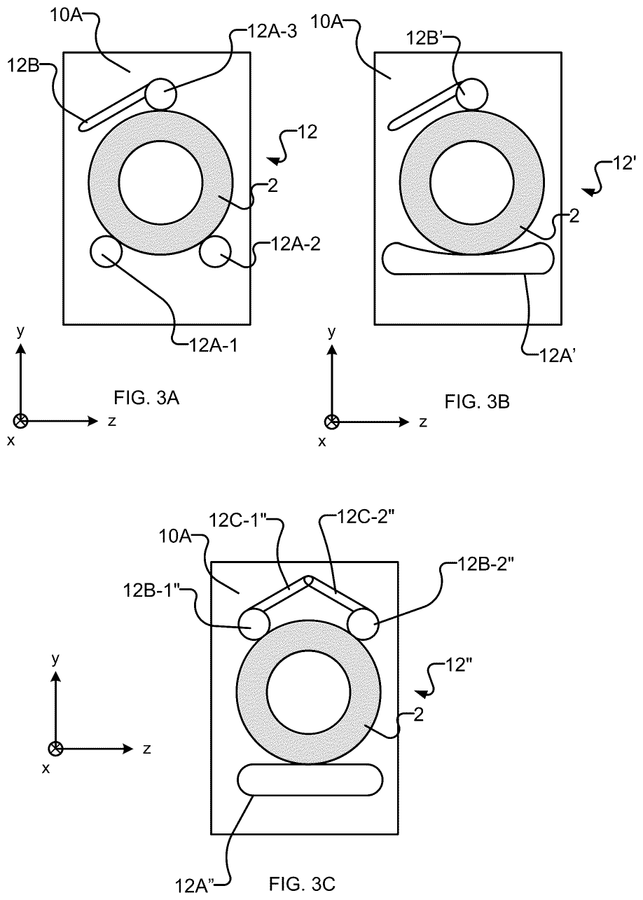

FIG. 3A is a schematic depiction of exemplary tire support features 12 suitable for use with apparatus 10. The FIG. 3A tire support features 12 comprise a plurality of rollers 12A-1, 12A-2, 12A-3 (collectively, rollers 12A). Rollers 12A may each comprise substantially cylindrical shaped rollers extending in the x-direction (or in directions generally parallel to rolling axis 3). Rollers 12A may have concave surfaces (e.g. about z-direction axes) and/or convex surfaces (e.g. about x-direction axes) which contact tire 2. In the FIG. 3A embodiment, tire 2 is supported on top of first and second rollers 12A-1, 12A-2. Each roller 12A may be supported for rotation (e.g. by one or more bearings) about its x-direction axis. First and second rollers 12A-1, 12A-2 may be fixed relative to one another (e.g. in the y and z-directions) but this is not mandatory and apparatus 10 may allow for adjustment of the position and/or orientation of one or both of first and second rollers 12A-1, 12A-2 in the y and/or z-directions (e.g. to accommodate tires 2 of different sizes). When tire 2 rests on first and second rollers 12A-2, 12A-2 as shown in FIG. 3A, rotation of first and second rollers 12A-2, 12A-2 about their x-direction axes may cause tire 2 to rotate about its rolling axis 3. Moreover, by driving rotation of one or both of first and second rollers 12A-2, 12A-2, tire 2 may be caused to rotate about its rolling axis 3 (e.g. due to friction between the driven roller(s) 12A and tire 2).

In some embodiments, a third roller 12A-3 is provided above first and second rollers 12A-1, 12A-2 to apply downward pressure on tire 2 to prevent (or mitigate the likelihood of) tire 2 from falling or rolling off first and second rollers 12A-1, 12A-2. Like first and second rollers 12A-1, 12A-2, third roller 12A-3 may extend in the x-direction and be supported to rotate about its x-direction axis so as to allow tire 2 to rotate about its rolling axis 3 despite contact of tire 2 with third roller 12A-3. A position and/or orientation of third roller 12A-3 in the y and z directions may be adjustable to accommodate tires 2 of different sizes (e.g. tires 2 of different diameters). One or more biasing elements 12B (e.g. springs, elastics, actuators, etc.) may be provided to bias third roller 12A-3 (in the z and/or y-directions) against tire 2 to accommodate tires 2 of different sizes (e.g. tires 2 of different diameters).

In some embodiments, to accommodate irregularities in the shape of tire 2 (e.g. due to outer tread surface 6B), one or more rollers 12A of tire support features 12 (e.g. third roller 12A-3), are made to be flexible (e.g. through material choice or by mechanical means). For example, in some embodiments, one or more rollers 12A of tire support features 12 are made of, or coated in, a softer material such as a rubber, elastomer, polymer etc. which can deform due to the force exerted by tire 2 on the roller 12A and/or the force exerted by roller 12A on tire 2. In other embodiments, one or more rollers 12A of tire support features 12 comprise flexible protrusions (not shown) that contact tire 2. In other embodiments, one or more rollers 12A of tire support features 12 comprise a plurality of flat annular rings (e.g. washers) threaded onto a rod extending in the X-direction wherein the rod diameter is smaller than the opening diameter of the rings. In this way, movement of the rings relative to the rod may accommodate irregularities in the shape of tire 2 (e.g. due to outer tread surface 6B) without losing contact between the one or more rollers 12A and tire 2.

As another example, FIG. 3B is a schematic depiction of alternative tire support features 12′. In the FIG. 3B embodiment, a belt 12A′ (e.g. similar to the belt of a treadmill) is provided to support tire 2. Belt 12A′ may in turn be entrained about and supported for rotation on a plurality of rollers (not depicted). Belt 12A′ may be curved (e.g. concave about an x-direction axis) as shown in FIG. 3B to effectively cradle tire 2 on belt 12A′ or belt may be relatively flat, as shown in FIG. 3C. The curve may be achieved by the positioning of rollers which support belt 12A′ sufficiently close together relative to the length of belt 12A′ to allow for slack in belt 12A'. For example, where belt 12A′ is supported at its ends by rollers, belt 12A′ may sag as shown in FIG. 3B thereby cradling tire 2 in place thereby preventing (or reducing a risk of) tire 2 from rolling off belt 12A'. The rotation of belt 12A′ may cause rotation of tire 2 in place about its rolling axis 3 when tire 2 is supported on belt 12A'. Moreover, by driving belt 12A', tire 2 may be caused to rotate about its rolling axis 3 (e.g. due to friction between belt 12A′ and tire 2). In the FIG. 3B embodiment, a roller 12B′ may be provided to apply downward pressure on tire 2 to prevent tire 2 from falling off belt 12A'. Roller 12B′ may be substantially similar to third roller 12A-3 of the FIG. 3A embodiment.

As another example, FIG. 3C is a schematic depiction of alternative tire support features 12″. Tire support features 12″ are substantially similar to tire support features 12′ except in that belt 12A″ is flat rather than curved. To prevent tire 2 from rolling off belt 12A“, first and second rollers 12B-1″ and 12B-2″ may be provided above belt 12A”. Each of first and second rollers 12B-1″ and 12B-2 may be substantially similar to third roller 12A-3 of the FIG. 3A embodiment. Positions of first and second rollers 12B-1″ and 12B-2 in the y and z directions may be adjustable to accommodate tires 2 of different sizes (e.g. tires 2 of different diameters). One or more biasing elements 12C-1″, 12C-2″ (e.g. springs, elastics, actuators, etc.) may be provided to bias first and second rollers 12B-1″ and 12B-2 (in the z and/or y-directions) against tire 2 to accommodate tires 2 of different sizes (e.g. tires 2 of different diameters). The embodiments of FIGS. 3A and 3B may be provided with a plurality of upper rollers similar to rollers 12B-1″ and 12B-2″.

Apparatus 10 may comprise a sensing system 13. Sensing system 13 may comprise one or more sensors 14 for determining the cross-sectional shape of a particular radial slice 5 of tire 2 at a given moment when tire 2 is supported by tire support features 12. In this description, sensors 14 are described as being arranged and configured for determining the cross-sectional shape of a radial slice 5A of tire 2 (e.g. the radial slice 5 of tire 2 at 6 o'clock at a given instant) when tire 2 is supported by tire support features 12. However, it should be understood that sensors 14 could alternatively or additionally be arranged and configured for determining the cross-sectional shape of different radial slices 5 of tire 2 at any given instant (e.g. radial slices 5 of tire 2 located at orientations about rolling axis 3 different from 6 o'clock at the given instant).

Sensors 14 may each comprise any suitable type of sensor. In some embodiments, each sensor 14 comprises a camera or an optical sensor such as, but not limited to, a complementary metal oxide semiconductor sensor (commonly referred to as a CMOS sensor), a charge-coupled device (commonly referred to as a CCD sensor), a position sensitive device (commonly referred to as a PSD sensor), etc. Sensors 14 may produce monochrome images. Sensors 14 may be provided with any suitable lens or combination of lenses. In some embodiments, one or more sensors 14 are provided with a wide angle lens. In some embodiments, one or more mirrors may be provided to achieve a desired field of view of one or more sensors 14.

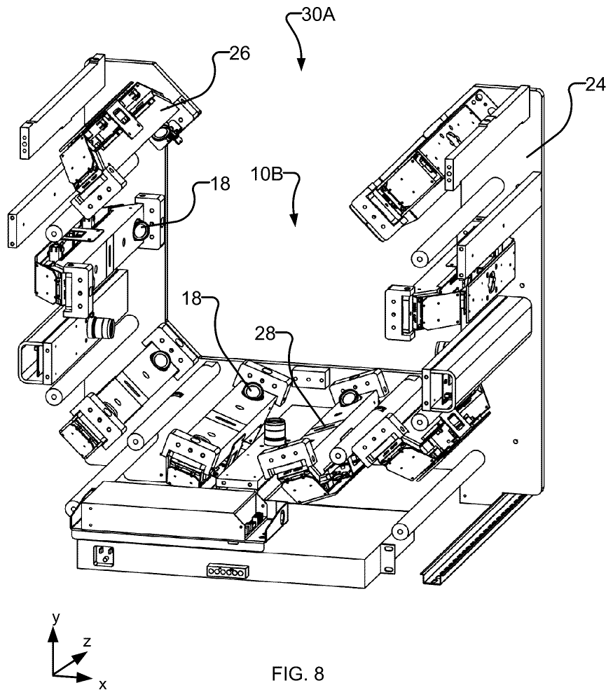

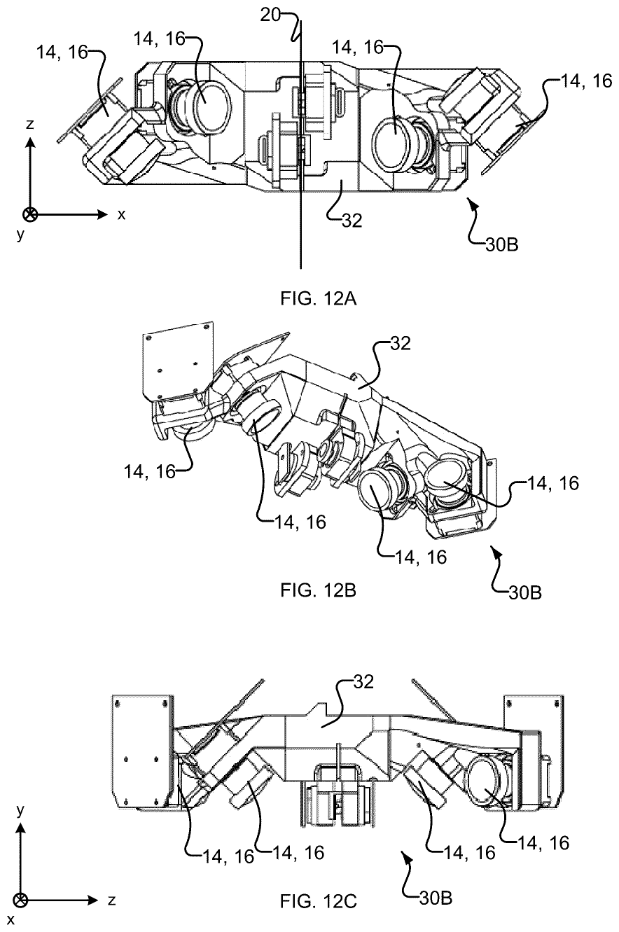

In some embodiments, sensors 14 comprise outer sensors 18 employable for determining an outer portion of the cross-sectional shape of a radial slice 5A of tire 2 (e.g. the cross-sectional shape of outer surface 6 for a radial slice 5A of tire 2). In some embodiments, sensors 14 comprise inner sensor(s) 16 employable for determining an inner portion of the cross-sectional shape of a radial slice 5A of tire 2 (e.g. the cross-sectional shape of inner surface 4 for a radial slice 5A of tire 2), although this is not mandatory. For example, sensing system 13 may comprise an outer sensor assembly 30A comprising outer sensors 18 and an inner sensor assembly 30B comprising inner sensors 16. FIG. 8 depicts an exemplary embodiment of an outer sensor assembly 30A. FIGS. 12A to 12C depict a portion of an exemplary embodiment of an inner sensor assembly 30B.

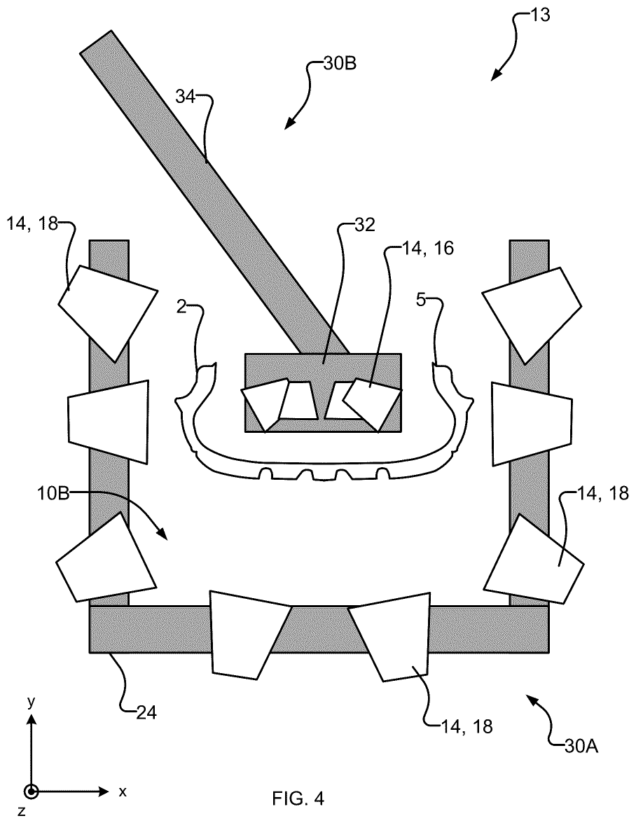

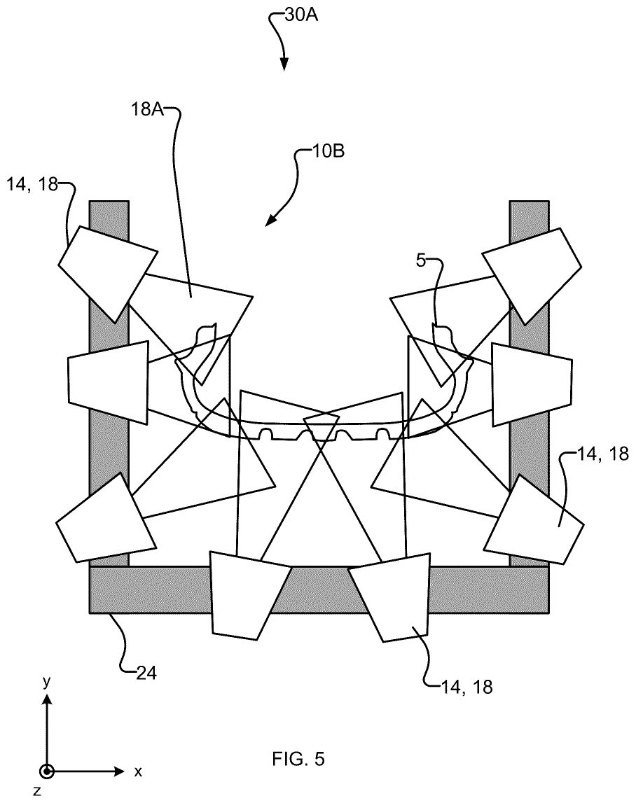

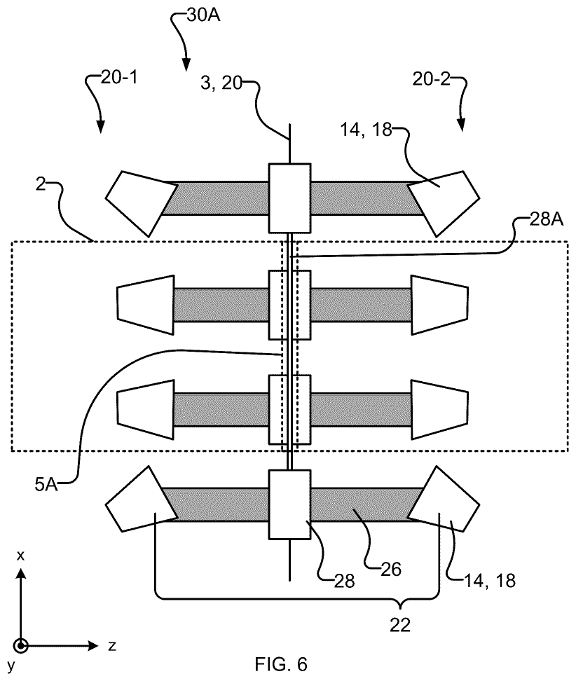

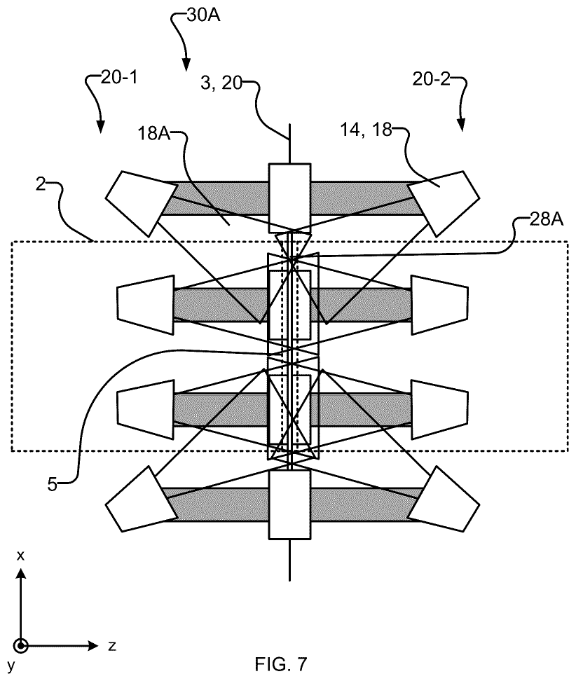

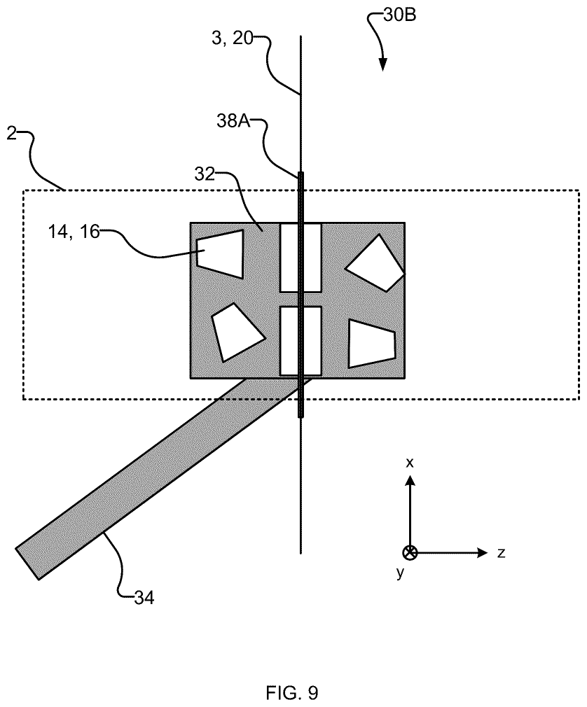

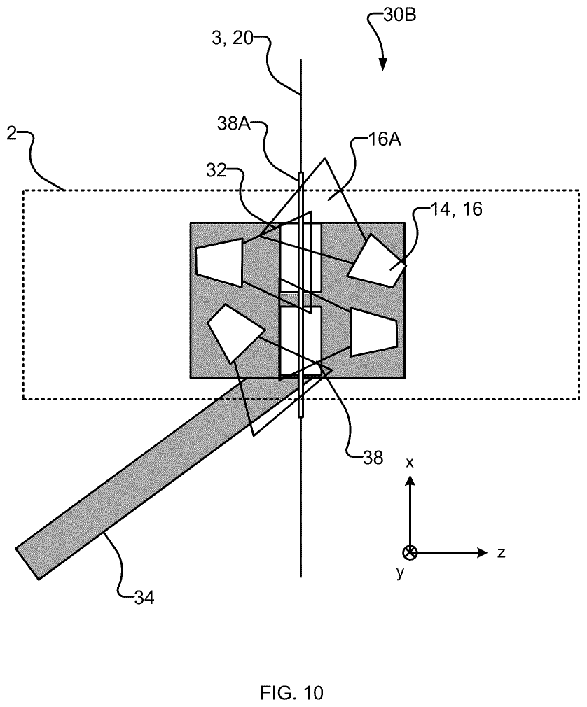

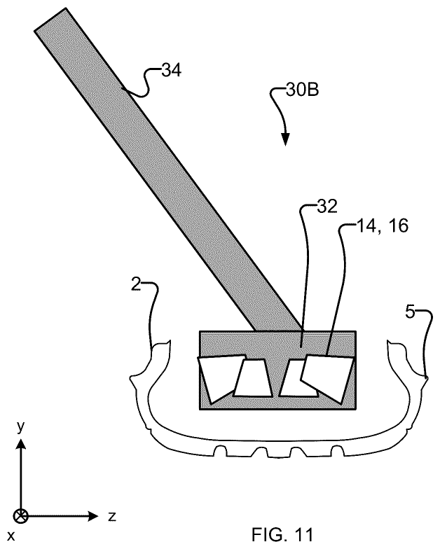

FIG. 4 is a schematic cross-sectional depiction of an exemplary sensing system 13 having a plurality of sensors 14 arranged in relation to radial slice 5A of tire 2. FIG. 5 is a front view schematic depiction of an exemplary outer sensor assembly 30A. FIGS. 6 and 7 are top down schematic depictions of an exemplary outer sensor assembly 30A. FIGS. 9 and 10 are bottom up schematic depictions of an exemplary inner sensor assembly 30B. FIG. 11 is a front view of a schematic depiction of an exemplary inner sensor assembly 30B.

Outer sensors 18 may be arranged to capture data representative of a surface geometry of at least a portion of outer surface 6 of tire 2. In some embodiments, outer sensors 18 are arranged to capture data representative of a surface geometry of at least a portion of outer surface 6 of radial slice 5A of tire 2. In some embodiments, outer sensors 18 are arranged to capture data representative of a surface geometry of a portion of outer surface 6 of tire 2 that intersects with an imaging plane 20. Imaging plane 20 may include rolling axis 3 if tire 2 is centered on apparatus 10 and oriented in an upright location.

In some embodiments, outer sensors 18 are spaced apart in the X and Y-directions around outer surface 6 of radial slice 5A of tire 2. In some embodiments, outer sensors 18 are arranged such that when viewed from the z-direction, outer sensors 18 appears to be arranged in a substantially U-shape (or V-shape or the like) as shown in FIG. 4. In the FIG. 4 embodiment, eight outer sensors 18 are depicted as being arranged in a substantially U-shape around radial slice 5A of tire 2. However, sensors 14 may comprise different numbers of (e.g. more or less than eight) outer sensors 18.

Outer sensors 18 may be arranged such that the fields of view 18A of outer sensors 18 capture an entirety or substantially an entirety of the outer surface 6 of radial slice 5A of tire 2. In some embodiments, the fields of view 18A of two or more of outer sensors 18 overlap (e.g. as can be seen in FIGS. 5 and 7). Such overlap of the fields of view 18A of outer sensors 18 may facilitate determining the surface geometry of outer surface 6 of tire 2 where there are surface features such as peaks and valleys (e.g. due to outer tread surface 6B) which directly obscure or cast shadows over portions of outer surface 6 when viewed only by a single outer sensor 18.

In some embodiments, some or all of sensors 18 are arranged to be centered on a single XY-plane such that at least a portion of each sensor 18 intersects with that XY-plane.

For example, in some embodiments, some or all of sensors 18 are arranged at spaced apart locations in imaging plane 20 such that at least a portion of each sensor 18 intersects imaging plane 20. Imaging plane 20 may be substantially co-planar with radial slice 5A. Imaging plane 20 may include rolling axis 3. In some embodiments, all sensors 18 are arranged at spaced apart locations on a first side 20-1 of imaging plane 20. In some embodiments, all sensors 18 are arranged at spaced apart locations on a second side 20-2 of imaging plane 20. In some embodiments, one or more sensors 18 are located on first side 20-1 of imaging plane 20 while one or more sensors 18 are located on second side 20-2 of imaging plane 20. In some embodiments, sensors 18 are arranged in pairs 22 wherein each pair 22 of sensors 18 includes a first sensor 18 on first side 20-1 of imaging plane 20 and a second sensor 18 on second side 20-2 of imaging plane 20 as shown, for example, in FIGS. 6, 7 and 8.

FIG. 7 shows four pairs 22 of sensors 18 wherein each pair 22 of sensors 18 comprises a sensor 18 on first side 20-1 and a corresponding sensor 18 on second side 20-2. However, it should be understood that sensors 18 could comprise more than four pairs 22 of sensors 18.

Each pair 22 of sensors 18 may be directed to capture surface geometry data of a particular portion of outer surface 6 of radial slice 5A of tire 2. For example, one or more first pairs 22 of sensors 18 may be directed at first outer sidewall surface 6A-1, one or more second pairs 22 of sensors 18 may be directed at second outer sidewall surface 6A-2 and/or one or more third pairs of sensors 18 may be directed at outer tread surface 6B.

In some embodiments, the location and/or orientation of sensors 18 of a pair 22 are mirrored about imaging plane 20, although this is not mandatory. For example, the X and/or Y-direction locations of each sensor 18 of a pair 22 may be mirror symmetric about imaging plane 20, and/or the orientation (e.g. about X, Y and/or Z-direction axes) of each sensor 18 of a pair 22 may be mirror symmetric about imaging plane 20.

For each pair 22, the field of view 18A of sensor 18 on first side 20-1 may overlap with the field of view 18A of the corresponding sensor 18 of pair 22 on second side 20-2. For each pair 22, the field of view 18A of sensor 18 on first side 20-1 may capture features of outer surface 6 of tire 2 that are obscured from the field of view 18A of the corresponding sensor 18 of pair 22 on second side 20-2 (e.g. due to surface features and/or irregularities on outer surface 6 such as the peaks and valleys of outer tread surface 6B) and likewise, the field of view 18A of sensor 18 on second side 20-2 may capture features of outer surface 6 of tire 2 that are obscured from the field of view 18A of the corresponding sensor 18 on first side 20-1 (e.g. due to surface features and/or irregularities on outer surface 6 such as the peaks and valleys of outer tread surface 6B). In this way, by arranging sensors 18 in pairs 22 on opposite sides of imaging plane 20, sensors 18 may be better able to capture the entirety of the geometry of outer surface 6 of tire 2.

Sensors 18 may be attached to and/or supported by apparatus 10 in any suitable manner. In some embodiments, sensors 18 are supported by an outer sensor bracket 24 attached to body 10A of apparatus 10. In some embodiments, individual sensors 18 are supported by one or more arms attached to outer sensor bracket 24. For example, in FIG. 6, each pair 22 of sensors 18 is supported by an arm 26 attached to outer sensor bracket 24.

In some embodiments, one or more light sources 28 project light onto outer surface 6 of tire 2 to better allow sensors 18 to capture the geometry of outer surface 6. In some embodiments, light sources 28 project light along imaging plane 20 and/or onto the intersection of imaging plane 20 with outer surface 6. Light sources 28 may comprise any suitable light sources. In some embodiments, light sources 28 comprise one or more laser projectors which project onto the outer surface 6. In some embodiments, the laser projectors are planar laser projectors that project a substantially planar laser beam. In some embodiments, light sources 28 project corresponding planar beams 28A that are each substantially co-planar with imaging plane 20. In some embodiments, one or more mirrors may be provided to direct beams 28A as desired (e.g. to direct beams 28A to be substantially co-planar to imaging plane 20).

In some embodiments, light sources 28 all project light of substantially the same wavelength. In some embodiments, some light sources 28 project light of different wavelengths. For example, where the light of two light sources 28 overlaps (as discussed further herein), these light sources may project light of different wavelengths to facilitate differentiating between light of one light source 28 from light of another light source 28. Employing light sources 28 of different wavelengths may help to accommodate light sources 28 that are not precisely aligned but may entail further processing of the output of sensors 14.

In some embodiments, light sources 28 are spaced apart around radial slice 5A of tire 2 such that when viewed from the Z-direction, light sources 28 appears to be arranged in a substantially U-shape (or V-shape or the like). In some embodiments, the beams 28A of one or more light sources 28 overlap. Such overlap of the beams 28A of light sources 28 may facilitate illuminating the entirety (or substantially close to the entirety) of outer surface 6 of radial slice 5A, even where there are surface features such as peaks and valleys (e.g. due to outer tread surface 6B) which obscure portions of outer surface 6 of radial slice 5A when illuminated only by a single light source 28. In some embodiments, light sources 28 are supported on outer sensor bracket 24. For example, as shown in FIG. 6, light sources 28 may be supported by arms 26. In some embodiments, a light source 28 is provided for each pair 22 of sensors 18, although this is not mandatory.

Sensors 18 may be employed to track the geometry of the intersection of beams 28A with outer surface 6 of tire. Where planar laser beam 28A is substantially co-planar with imaging plane 20 which is in turn substantially co-planar with radial slice 5A, sensors 18 can be employed to determine the cross-sectional shape of outer surface 6 of a radial slice 5A of tire 2 by tracking the intersection of beams 28A with outer surface 6 of tire 2. Together, light sources 28 and sensors 18 may be employed for one or more scanning techniques such as time-of-flight techniques, triangulation techniques, etc. For example, triangulation techniques such as those described in U.S. Pat. No. 7,460,250 entitled Laser Triangulation System may be employed to determine the outer cross-sectional shape of radial slice 5A of tire 2 based on the output of sensors 18. U.S. Pat. No. 7,460,250 is hereby incorporated herein by reference.

Inner sensors 16 may be arranged to capture data representative of a surface geometry of at least a portion of inner surface 4 of tire 2. In some embodiments, inner sensors 16 are arranged to capture data representative of a surface geometry of at least a portion of inner surface 4 of radial slice 5A of tire 2 (e.g. the radial slice 5 of tire 2 located at 6 o'clock at a given instant).

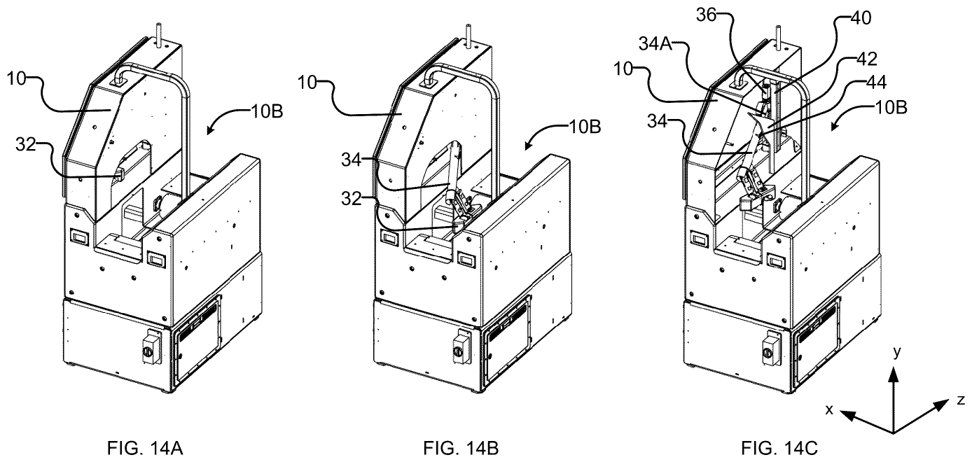

Inner sensors 16 may be located on an inner sensor head 32. Inner sensor head 32 may be attached to an adjustable arm 34. Adjustable arm may be actuatable or moveable to facilitate loading and/or unloading of tires 2 into and out of apparatus 10. For example, as can be seen from FIGS. 14A, 14B and 14C, sensor head 32 may moveable between a first position (e.g. as shown in FIG. 14A) in which sensor head 32 is at least partially removed from space 10B(e.g. to allow loading and unloading of tire 2 into and out of apparatus 10) and a second position (e.g. as shown in FIG. 14B) in which sensor head 32 is at least partially located in space 10B (such that if a tire 2 were loaded in apparatus 10, sensor head 32 would be located at least partially in cavity 4C (FIG. 1B) of tire 2) by actuation of arm 34.

Adjustable arm 34 may be attached to body 10A of apparatus 10 by one or more pivoting, sliding and/or other mechanical connections or the like to allow inner sensor head 32 to be inserted into a cavity 4C defined at least in part by inner surface 4 of lower portion 2B of tire 2. Apparatus 10 may comprise one or more motors, actuators or the like to control adjustable arm 34 to move sensor head 32 into cavity 4C and remove sensor head 32 from cavity 4C as desired. Adjustable arm 34 may be manually controlled or automatically controlled. For example, adjustable arm 34 may be automatically controlled based at least in part on an expected size and/or geometry of tire 2 and/or one or more sensors (not expressly shown) employed to guide inner sensor head 32 into cavity 4C.

FIG. 14C depicts at least a portion of an exemplary mechanism for control of adjustable arm 34. One or more portions of apparatus 10 have been removed in FIG. 14 to better show the exemplary mechanism for control of adjustable arm 34 of FIG. 14C. In the FIG. 14C embodiment, adjustable arm 34 is rotatably attached (e.g. by a bearing) to a shaft 36 extending in the y-direction to thereby allow rotational movement of adjustable arm 34. Shaft 36 is in turn slidably attached to a linear slide 40 extending in y-direction and attached to body 10A to thereby allow y-direction movement of adjustable arm 34. A guide cam 42 attached to body 10A and a cam follower 44 attached to adjustable arm 34 may work together (with an optional torsion spring or the like) to cause adjustable arm 34 to pivot about its proximal end 34A and/or rotate about shaft 36 as shaft 36 is raised or lowered on linear slide 40 thereby moving sensor head 32 between the first position in which sensor head 32 is at least partially removed from space 10B and the second position in which sensor head is at least partially located in space 10B.

Inner sensors 16 may comprise one or more inner sensors 16 aimed generally at inner tread surface 4B, one or more inner sensors 16 aimed generally at first inner sidewall surface 4A-1 and one or more inner sensors 16 aimed generally at the second inner sidewall surface 4A-2. In the FIG. 4 embodiment, two inner sensors 16 are aimed generally at inner tread surface 4B, one sensor 16 is aimed generally at first inner sidewall surface 4A-1 and one inner sensor 16 is aimed generally at the second inner sidewall surface 4A-2. In some embodiments, inner sensors 16 directed to first inner sidewall surface 4A-1 and second inner sidewall surface 4A-2 may be provided with wide angle lenses to facilitate capturing the entirety of first and second inner sidewalls 4A-1, 4A-2 (e.g. including concave portions of first and second inner sidewalls 4A-1, 4A-2 under first and second beads 8-1, 8-2). However, it should be understood that different numbers of (e.g. more or fewer inner than four) sensors 16 could be provided.

Inner sensors 16 may be arranged such that the fields of view 16A of inner sensors 16 capture an entirety or substantially an entirety of the inner surface 4 of radial slice 5A of tire 2. In some embodiments, the fields of view 16A of two or more of inner sensors 16 overlap (e.g. as can be seen in FIG. 10). Such overlap of the fields of view 16A of inner sensors 16 may facilitate determining the surface geometry of inner surface 4 of tire 2 where there may be surface features which directly obscure or cast shadows over portions of inner surface 4 when viewed only by a single inner sensor 16.

In some embodiments, some or all of sensors 16 are arranged to be centered on a single XY-plane such that at least a portion of each sensor 16 intersects with that XY-plane. For example, in some embodiments, some or all of sensors 16 are arranged at spaced apart locations on imaging plane 20 such that at least a portion of each sensor 16 intersects imaging plane 20. In some embodiments, all sensors 16 are arranged at spaced apart locations on a first side 20-1 of imaging plane 20. In some embodiments, all sensors 16 are arranged at spaced apart locations on a second side 20-2 of imaging plane 20. In some embodiments, one or more sensors 16 are located on first side 20-1 of imaging plane 20 while one or more sensors 16 are located on second side 20-2 of imaging plane 20. By locating sensors 16 on both sides of imaging plane 20 (e.g. as shown in FIGS. 12A-12C), the size of sensor head 32 may be reduced thereby facilitating insertion of sensor head 32 into cavity 4C (see FIG. 1B) and facilitating use of apparatus 10 with relatively smaller tires.

In some embodiments, one or more light sources 38 project light onto inner surface 4 of tire 2 to better allow sensors 16 to capture the geometry of inner surface 4. In some embodiments, light sources 38 project light along imaging plane 20 and/or onto the intersection of imaging plane 20 with inner surface 4. In some embodiments, one or more mirrors may be provided to direct beams 38A as desired (e.g. to direct beams 38A substantially co-planar to imaging plane 20). Light sources 38 may be substantially similar to light sources 28. In some embodiments, the beams 38A of one or more light sources 38 overlap. Such overlap of the beams 38A of light sources 38 may facilitate illuminating the entirety (or substantially close to the entirety)of inner surface 4 of radial slice 5A, even where there are surface features which obscure portions of inner surface 4 when illuminated only by a single light source 38. In some embodiments, light sources 38 are supported on inner sensor head 32.

Sensors 16 may be employed to track the geometry of the intersection of beams 38A with inner surface 4 of tire. Where beams 38A are substantially co-planar with imaging plane 20 which is in turn substantially co-planar with radial slice 5A, sensors 16 can be employed to determine the cross-sectional shape of inner surface 4 of a radial slice 5A of tire 2 by tracking the intersection of beams 38A with inner surface 4 of tire 2. Together, light sources 38 and sensors 16 may be employed for one or more scanning techniques such as time-of-flight techniques, triangulation techniques, etc. For example, triangulation techniques such as those described in U.S. Pat. No. 7,460,250 entitled Laser Triangulation System may be employed to determine the inner cross-sectional shape of a radial slice 5A of tire 2 based on the output of sensors 16.

Apparatus 10 may comprise one or more additional sensors to identify foreign matter attached to or incorporated in tire 2. For example, apparatus 10 may comprise one or more colour or greyscale cameras to detect foreign matter attached to or incorporated in tire 2. These additional sensors or cameras may be arranged to capture images of the exterior surface 6 of tire 2 (e.g. one or more of tread surface 6B and first and second sidewalls 6A-1, 6A-2), the interior surface 4 of tire 2 (e.g. one or more of inner tread surface 4B and first and second inner sidewalls 4A-1, 4A-2) and/or first and second beads 8-1, 8-2. Output of these additional sensors or cameras may be monitored manually (e.g. by an operator of apparatus 10) or automatically (e.g. with suitable software such as software employing artificial intelligence or machine learning).

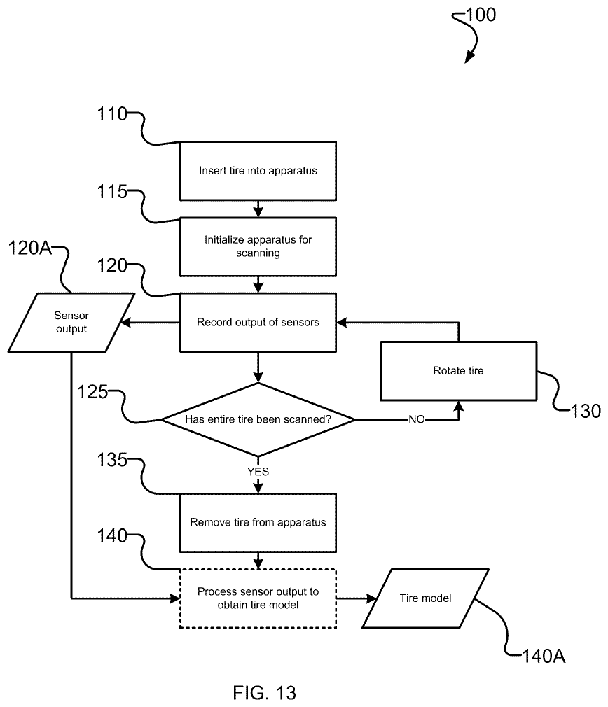

Another aspect of the invention provides a method for tire scanning. FIG. 13 depicts an exemplary tire scanning method 100 for tire scanning according to one embodiment of the invention. Method 100 may employ apparatus 10 and for ease of description, method 100 is described herein in relation to apparatus 10. However, it should be understood that this is not mandatory and method 100 may employ other tire scanning apparatus.

At block 110, a tire 2 is inserted into position in apparatus 10. For example, tire 2 may be placed at least partially within space 10B. Tire 2 may be inserted into position on tire support features 12 (e.g. rollers 12A-1, 12A-2, etc.) at block 110. Tire 2 may be inserted into position in apparatus 10 manually or automatically (e.g. by a suitable robotic arm, conveyor belt, etc.). In some embodiments, tire 2 is rolled into position in apparatus 10 (e.g. in the z-direction). In some embodiments, rolling axis 3 of tire 2 may be generally horizontal (e.g. tire 2 may be upright) at the conclusion of block 110.

Block 110 may comprise moving inner sensor head 32 out of space 10B to facilitate inserting tire 2 into position on apparatus 10 (e.g. where an inner sensor head 32 is present). Moving inner sensor head 32 may comprise actuating arm 34 (e.g. manually or automatically) to withdraw inner sensor head 34 from space 10B of apparatus 10. In some embodiments, inner sensor head 32 is moved into a cavity defined by body 10A of apparatus 10 (e.g. as shown in FIG. 14A). In some embodiments, moving inner sensor head 32 out of space 10B at block 110 is not necessary (e.g. since inner sensor head 32 may already have been moved out of space 10B to facilitate removal of a tire 2 recently inspected by apparatus 10).

At block 115, tire scanning apparatus 10 is initialized for scanning. Initializing apparatus 10 for scanning may include, for example, one or more of securing tire 2 in position on apparatus 10, moving inner sensor head 32 into position (e.g. where inner sensor head 32 is present), turning on one or more of light sources 28, 38, turning on one or more of sensors 14, inputting expected dimensions of tire 2 into a control algorithm of apparatus 10, etc. In some embodiments, one or more steps of block 115 occur prior to block 110 or after block 115.

Where tire support features 12 include one or more adjustable support features (e.g. rollers 12A-3, 12B′, 12C-1″, 12C-2″, etc.), such adjustable support features may be moved into contact with tire 2 to appropriately secure tire 2 at block 115, as desired. The adjustable support features may be moved into position manually or automatically (e.g. roller 12A-3 may be moved into position by one or more actuators controlling biasing element 12B).

Moving inner sensor head 32 into position at block 115 may comprise inserting at least a portion of inner sensor head 32 into cavity 4C of tire 2. The exact position of inner sensor head 32 at block 115 may be dependent on the size and/or shape of tire 2 (e.g. as expected or as determined by one or more sensors employed to guide inner sensor head 32). Inner sensor head 32 may be moved into position manually or automatically (e.g. by actuating one or more actuators that control arm 34 to which inner sensor head 32 is attached). In some embodiments, rolling axis 3 of tire 2 may be generally horizontal (e.g. tire 2 may be upright) at the conclusion of block 115.

At block 120, method 100 comprises recording the output 120A of sensors 14. The output of all sensors 14 (including inner sensors 16 when present and outer sensors 18) may be taken simultaneously at block 120. In this way, the output 120A corresponding to inner surface 4 and outer surface 6 may be aligned through suitable processing (e.g. at optional step 140) thereby allowing determination of a thickness (e.g. radial thickness) and/or surface profile of any part of tire 2 which may allow for identification of various flaws, if present. Sensor output 120A may be stored, for example, in internal memory of apparatus 10, an external memory connected (wired or wirelessly) to apparatus 10, in a cloud-based data storage device, etc. Sensor output 120A may comprise data (e.g. point cloud data) representing the surface geometry of inner surface 4 and outer surface 6 of radial slice 5A of tire 2. Sensor output 120A may comprise data (e.g. point cloud data) representing the surface geometry of inner surface 4 and outer surface 6 of tire 2 where imaging plane 20 intersects with tire 2.

For the first occurrence of block 120, sensor output 120A corresponds to a first radial slice 5 of tire 2 (e.g. a slice 5 of tire 2 at a particular angular orientation of tire 2 about rolling axis 3). For a second occurrence of block 120, method 100, sensor output 120A corresponds to a second radial slice 5 of tire 2 circumferentially spaced apart from the first radial slice 5 of tire 2 about rolling axis 3. For each further occurrence of block 120, sensor output 120A corresponds to further radial slices 5 of tire 2 further circumferentially spaced apart from the first radial slice 5 of tire 2 about rolling axis 3. Sensor output 120A may be timestamped or otherwise indexed to facilitate processing of sensor output 120A (e.g. to associate particular sensor output 120A with particular radial slices 5 of tire 2) at another step (e.g. at block 140 of method 100). Sensor output 120A may be associated with output of an encoder driven by rotation of tire 2 about rolling axis 3 (e.g. to associate particular sensor output 120A with particular radial slices 5 of tire 2) at another step (e.g. at block 140 of method 100).

At block 125, if the entire circumference of tire 2 has not be scanned, then method 100 continues to block 130. At block 125, determining whether or not the entire circumference of tire 2 has been scanned may be determined, for example, based at least in part on expected dimensions of tire 2 and a speed of rotation of tire 2, based on analysis of sensor output 120A and/or by one or more additional sensors of apparatus 10 (e.g. apparatus 10 may comprise an encoder or the like to track rotation of tire 2). In some embodiments, block 125 allows one or more portions of tire 2 to be scanned multiple times (e.g. for redundancy).

At block 130, tire 2 is rotated about its rolling axis 3 to align imaging plane 20 with a further radial slice 5 of tire 2. For the first occurrence of block 130, tire 2 may be rotated until second radial slice 5 is aligned with imaging plane 20. For further occurrences of block 130, tire 2 may be rotated to align further radial slices 5 with imaging plane 20.

Tire 2 may be rotated about its rolling axis 3 by any suitable method. In some embodiments, one or more tire support features 12 are actuated to thereby cause tire 2 to rotate (e.g. due to friction between outer surface 6 of tire 2 and the rotating tire support feature 12). Tire 2 may be rotated at block 130 by any suitable amount. In some embodiments, tire 2 is rotated by an angular amount about rolling axis 3 between approximately 0.0002° and 0.01°. In some embodiments, tire 2 is rotated by between approximately 0.05 mm and 0.08 mm (as measured along the outer circumference of tire 2). In some embodiments, the amount of rotation of tire 2 at block 130 is based at least in part on a selected recording time interval of sensors 14 (e.g. tire 2 rotates at a constant speed and the amount of rotation at block 130 is dependent on the frequency of recordings taken by sensors 14). In either case, the amount of rotation of tire 2 at block 130 may be dependent on various factors such as, for example, the inherent constraints of sensors 14 (e.g. measurement frequency constraints of sensors 14), a desired precision or resolution of output 120A of tire scanning method 100, the size (e.g. diameter) of tire 2, time constraints of method 100, data sampling and/or processing resources, etc.

Once tire 2 is rotated by a desired magnitude at block 130 or a sufficient time interval has elapsed since block 120, method 100 returns to block 120 from block 130 and output 120A of sensors 14 is again recorded. Again, output 120A of all sensors 14 may be obtained simultaneously. Again, sensor output 120A may be timestamped or otherwise indexed (e.g. associated with output of an encoder tracking rotation of tire 2) to facilitate processing of sensor output 120A at another step (e.g. at block 140 of method 100).

Blocks 120 and 130 may be repeated as discussed above until a desired portion of the circumference of tire 2 has been scanned, at which point method 100 continues from block 125 to block 135. In some embodiments, blocks 120 and 130 are repeated as discussed above until tire 2 has been rotated by one full rotation and the entire circumference of tire 2 has been scanned. In some embodiments, blocks 120 and 130 are repeated as discussed above until tire 2 has been rotated by more than one full rotation (e.g. by 5% more, 10% more or more) and the entire circumference of tire 2 has been scanned at least once and at least a portion of the circumference of tire 2 has been scanned twice (e.g. to account for stop and/or start latencies).

In some embodiments, blocks 120 and 130 effectively occur continuously such that tire 2 is continuously rotated at a selected speed and output 120A is recorded at selected intervals.

At block 135, tire 2 is removed from apparatus 10. Tire 2 may be removed manually or automatically. For example, tire 2 may be removed by moving third roller 12A-3 (or roller 12B′ or rollers 12B-1″, 12B-″) away from tire 2 and allowing tire 2 to roll out of apparatus 10. To facilitate rolling tire 2 out of apparatus 10, tire 2 may be pushed by an operator (e.g. manually), by an appropriate actuator, by an incoming tire 2 that is being rolled into apparatus 10, or by other suitable means.

Method 100 may end at block 135. Alternatively, method 100 may include block 140. Block 140 comprises processing sensor output 120A to obtain a three dimensional model 140A of tire 2. For example, based at least in part on one or more of the speed of rotation of tire 2, known relative positions of sensors 14 and timestamps (and/or rotational indices) of sensor output 120A, sensor output 120A may be processed (e.g. by suitable stitching, smoothing, cleaning, interpolation etc.) to create a three dimensional model 140A of tire 2. Processing of sensor output 120A may include accommodating for deformation of tire 2 on apparatus 10 (e.g. wobble, wander, etc.)

Model 140A may be employed to find flaws such as undesirable bulges, bumps, lumps, cracks, thin sections, inclusions, holes, gaps, seams, cuts, etc. in tire 2. Such flaws may be found, at least in part, by comparing model 140A to an expected geometry of tire 2 (while accounting for some acceptable variation) and/or by comparing model 140A to threshold values for tires generally (e.g. tires should have a minimum thickness throughout, etc.).

### Interpretation of Terms

Unless the context clearly requires otherwise, throughout the description and the claims:
“comprise”, “comprising”, and the like are to be construed in an inclusive sense, as opposed to an exclusive or exhaustive sense; that is to say, in the sense of “including, but not limited to”;
“connected”, “coupled”, or any variant thereof, means any connection or coupling, either direct or indirect, between two or more elements; the coupling or connection between the elements can be physical, logical, or a combination thereof;
“herein”, “above”, “below”, and words of similar import, when used to describe this specification, shall refer to this specification as a whole, and not to any particular portions of this specification;
“or”, in reference to a list of two or more items, covers all of the following interpretations of the word: any of the items in the list, all of the items in the list, and any combination of the items in the list;
the singular forms “a”, “an”, and “the” also include the meaning of any appropriate plural forms.

While processes or blocks are presented in a given order, alternative examples may perform routines having steps, or employ systems having blocks, in a different order, and some processes or blocks may be deleted, moved, added, subdivided, combined, and/or modified to provide alternative or subcombinations. Each of these processes or blocks may be implemented in a variety of different ways. Also, while processes or blocks are at times shown as being performed in series, these processes or blocks may instead be performed in parallel, or may be performed at different times.

In addition, while elements are at times shown as being performed sequentially, they may instead be performed simultaneously or in different sequences. It is therefore intended that the following claims are interpreted to include all such variations as are within their intended scope.

Where a component is referred to above, unless otherwise indicated, reference to that component (including a reference to a “means”) should be interpreted as including as equivalents of that component any component which performs the function of the described component (i.e., that is functionally equivalent), including components which are not structurally equivalent to the disclosed structure which performs the function in the illustrated exemplary embodiments of the invention.

Specific examples of systems, methods and apparatus have been described herein for purposes of illustration. These are only examples. The technology provided herein can be applied to systems other than the example systems described above. Many alterations, modifications, additions, omissions, and permutations are possible within the practice of this invention. This invention includes variations on described embodiments that would be apparent to the skilled addressee, including variations obtained by: replacing features, elements and/or acts with equivalent features, elements and/or acts; mixing and matching of features, elements and/or acts from different embodiments; combining features, elements and/or acts from embodiments as described herein with features, elements and/or acts of other technology; and/or omitting combining features, elements and/or acts from described embodiments.

Various features are described herein as being present in “some embodiments”. Such features are not mandatory and may not be present in all embodiments. Embodiments of the invention may include zero, any one or any combination of two or more of such features. This is limited only to the extent that certain ones of such features are incompatible with other ones of such features in the sense that it would be impossible for a person of ordinary skill in the art to construct a practical embodiment that combines such incompatible features. Consequently, the description that “some embodiments” possess feature A and “some embodiments” possess feature B should be interpreted as an express indication that the inventors also contemplate embodiments which combine features A and B (unless the description states otherwise or features A and B are fundamentally incompatible).

The invention includes, without limitation, a number of aspects. Non-limiting aspects of the invention comprise:
1. A tire scanning apparatus, the tire scanning apparatus comprising:
   a body;
   one or more tire support features attached to the body for supporting a tire in a substantially upright orientation for rotation substantially in place about a rolling axis of the tire; and
   a plurality of outer sensors attached to the body to capture outer surface geometry data corresponding to an intersection of an imaging plane and an outer surface of a portion of the tire.
2. A tire scanning apparatus according to aspect 1 or any other aspect herein wherein an inner sensor head moveably connected to the body, the inner sensor head positionable within a cavity defined by an inner surface of the tire to capture inner surface geometry data corresponding to an intersection of the imaging plane and an inner surface of the portion of the tire.
3. A tire scanning apparatus according to any one of aspects 1 and 2 or any other aspect herein wherein the portion of the tire is a lower portion of the tire.
4. A tire scanning apparatus according to any one of aspects 1 to 3 or any other aspect herein wherein the plurality of outer sensors comprises one or more first outer sensors directed to a first outer sidewall surface of the tire.
5. A tire scanning apparatus according to any one of aspects 1 to 4 or any other aspect herein wherein the plurality of outer sensors comprises one or more second outer sensors directed to a second outer sidewall surface of the tire.
6. A tire scanning apparatus according to any one of aspects 1 to 5 or any other aspect herein wherein the plurality of outer sensors comprises one or more third outer sensors directed to an outer tread surface of the tire.
7. A tire scanning apparatus according to any one of aspects 1 to 6 or any other aspect herein wherein the plurality of outer sensors are arranged in pairs of outer sensors and each pair of outer sensors comprises a first sensor of the pair of outer sensors on a first side of the imaging plane and a second sensor of the pair of outer sensors on a second side of the imaging plane.
8. A tire scanning apparatus according to aspect 7 or any other aspect herein wherein, for each pair of outer sensors, an orientation of the first sensor of the pair of outer sensors is mirror symmetric about the imaging plane to an orientation of the second sensor of the pair of outer sensors.
9. A tire scanning apparatus according to any one of aspects 7 and 8 or any other aspect herein wherein, for each pair of outer sensors, a location of the first sensor of the pair of outer sensors is mirror symmetric about the imaging plane to a location of the second sensor of the pair of outer sensors.
10. A tire scanning apparatus according to any one of aspects 1 to 9 or any other aspect herein wherein a combined field of view of the plurality of outer sensors captures the entirety of the intersection of the imaging plane with the outer surface of the portion of the tire.
11. A tire scanning apparatus according to any one of aspects 2 to 10 or any other aspect herein wherein a combined field of view of the plurality of inner sensors captures the entirety of the intersection of the imaging plane with the inner surface of the portion of the tire.
12. A tire scanning apparatus according to any one of aspects 1 to 11 or any other aspect herein comprising one or more outer light sources arranged to project light substantially co-planar to the imaging plane and onto the outer surface of the portion of the tire.
13. A tire scanning apparatus according to aspect 12 or any other aspect herein wherein the one or more outer light sources comprise one or more outer laser projectors.
14. A tire scanning apparatus according to aspect 13 or any other aspect herein wherein the one or more outer light sources comprise one or more planar laser projectors oriented to project laser light substantially co-planar with the imaging plane.
15. A tire scanning apparatus according to any one of aspects 2 to 14 or any other aspect herein wherein the plurality of inner sensors comprises one or more first inner sensors directed to a first inner sidewall surface of the tire.
16. A tire scanning apparatus according to any one of aspects 2 to 15 or any other aspect herein wherein the plurality of inner sensors comprises one or more second inner sensors directed to a second inner sidewall surface of the tire.
17. A tire scanning apparatus according to any one of aspects 2 to 16 or any other aspect herein wherein the plurality of inner sensors comprises one or more third inner sensors directed to an inner tread surface of the tire.
18. A tire scanning apparatus according to any one of aspects 2 to 14 or any other aspect herein wherein:
   the plurality of inner sensors comprises one or more first inner sensors directed to a first inner sidewall surface of the tire;
   the plurality of inner sensors comprises one or more second inner sensors directed to a second inner sidewall surface of the tire; and
   the one or more first inner sensors are located on a first side of the imaging plane and the one or more second inner sensors are located on a second side of the imaging plane.
19. A tire scanning apparatus according to any one of aspects 2 to 14 and 18 or any other aspect herein wherein:
   the plurality of inner sensors comprises one or more third inner sensors directed to an inner tread surface of the tire; and
   one of the one or more third inner sensors is located on a first side of the imaging plane and another one of the one or more third inner sensors is located on a second side of the imaging plane.
20. A tire scanning apparatus according to any one of aspects 1 to 14 or any other aspect herein wherein:
   the plurality of inner sensors comprises a first inner sensor directed to a first inner sidewall surface of the tire;
   the plurality of inner sensors comprises a second inner directed to a second inner sidewall surface of the tire; and
   the plurality of inner sensors comprises two third inner sensors directed to an inner tread surface of the tire.
21. A tire scanning apparatus according to any one of aspects 2 to 20 or any other aspect herein comprising one or more inner light sources arranged to project light onto the intersection of the imaging plane and the inner surface of the portion of the tire.
22. A tire scanning apparatus according to aspect 21 or any other aspect herein wherein the one more inner light sources comprise one or more inner laser projectors.
23. A tire scanning apparatus according to aspect 22 or any other aspect herein wherein the one more inner light sources comprise one or more inner planar laser projectors oriented to project laser light substantially co-planar with the imaging plane.
24. A tire scanning apparatus according to any one of aspects 1 to 23 or any other aspect herein wherein the tire support features comprise two or more lower rollers for rotatably supporting the tire in the substantially upright orientation.
25. A tire scanning apparatus according to any one of aspects 1 to 24 or any other aspect herein wherein the tire support features comprise a bias roller biasable down against the tire to keep the tire substantially in place.
26. A tire scanning apparatus according to aspect 25 or any other aspect herein wherein the bias roller comprises a plurality of annular rings threaded onto a rod such that the bias roller can accommodate inconsistencies in the shape of the tire.
27. A tire scanning apparatus according to any one of aspects 25 and 26 comprising a biasing element biasing the bias roller against the tire.
28. A tire scanning apparatus according to aspect 27 or any other aspect herein wherein the biasing element comprising one of a spring, an elastomeric component and an actuator.
29. A tire scanning apparatus according to aspect 24 or any other aspect herein comprising a belt supported by the two lower rollers wherein the tire is rotatably supported in the substantially upright orientation on the belt.
30. A tire scanning apparatus according to any one of aspects 2 to 9 or any other aspect herein wherein the inner sensor head is retractable to allow for insertion and removal of the tire from the tire scanning apparatus.
31. A tire scanning apparatus according to aspect 30 or any other aspect herein comprising an arm attached to the body, the arm actuatable to retract the inner sensor head to allow for insertion and removal of the tire from the tire scanning apparatus.
32. A tire scanning apparatus according to any one of aspects 1 to 31 or any other aspect herein wherein the rolling axis is generally horizontal.
33. A tire scanning apparatus according to any one of aspects 1 to 31 or any other aspect herein wherein an angle formed between the rolling axis and a horizontal is less than 10° or less than 5° or less than 2.5°.
34. a Method of Tire Scanning, the Method Comprising:
   supporting a tire in a substantially upright orientation for rotation substantially in place about a rolling axis of the tire;
   capturing first outer surface geometry data corresponding to an intersection of an imaging plane and an outer surface of a first radial slice of the tire;
   rotating the tire about the rolling axis of the tire;
   capturing second outer surface geometry data corresponding to an intersection of the imaging plane and an outer surface of a second radial slice of the tire.
35. A method of tire scanning according to aspect 34 or any other aspect herein, the method further comprising:
   positioning an inner sensor head within a cavity defined by an inner surface of the tire
   capturing first inner surface geometry data corresponding to an intersection of the imaging plane and an inner surface of the first radial slice of the tire; and
   after rotating the tire about the rolling axis of the tire:
      capturing second inner surface geometry data corresponding to an intersection of the imaging plane and an inner surface of the second radial slice of the tire
36. A method according to aspect 35 or any other aspect herein wherein capturing the first outer surface geometry data and the first inner surface geometry data occurs substantially simultaneously.
37. A method according to any one of aspects 35 to 36 or any other aspect herein wherein capturing the second outer surface geometry data and the second inner surface geometry data occurs substantially simultaneously.
38. A method according to any one of aspects 35 to 37 or any other aspect herein comprising rotating the tire about the rolling axis of the tire continuously while capturing the first outer surface geometry data, the first inner surface geometry data, the second outer surface geometry data and the second inner surface geometry data.
39. A method according to any one of aspects 34 to 38 or any other aspect herein wherein capturing first outer surface geometry data at the intersection of the imaging plane and the outer surface of the first radial slice of the tire comprises projecting light substantially co-planar to the imaging plane onto the intersection of the imaging plane and the outer surface of the first radial slice of the tire.
40. A method according to any one of aspects 35 to 39 or any other aspect herein wherein capturing first inner surface geometry data at the intersection of the imaging plane and the inner surface of the first radial slice of the tire comprises projecting light substantially co-planar to the imaging plane onto the intersection of the imaging plane and the inner surface of the first radial slice of the tire.
41. A method according to any one of aspects 35 to 40 comprising outputting a three-dimensional model of the tire based at least in part on the first outer surface geometry data, the first inner surface geometry data, the second outer surface geometry data and the second inner surface geometry data.
42. A method according to any one of aspects 34 to 41 or any other aspect herein wherein the rolling axis is generally horizontal.
43. A method according to any one of aspects 34 to 41 or any other aspect herein wherein an angle formed between the rolling axis and a horizontal is less than 10° or less than 5° or less than 2.5°.
44. A method according to any one of aspects 34 to 43 or any other aspect herein employing the tire scanning apparatus of any one of aspects 1 to 33 or any other aspect herein.
45. Methods comprising any features, combinations of features and/or sub-combinations of features described herein or inferable therefrom.
46. Apparatus comprising any features, combinations of features and/or sub-combinations of features described herein or inferable therefrom.
47. Kits comprising any features, combinations of features and/or sub-combinations of features described herein or inferable therefrom.

It is therefore intended that the following appended claims and claims hereafter introduced are interpreted to include all such modifications, permutations, additions, omissions, and sub-combinations as may reasonably be inferred. The scope of the claims should not be limited by the preferred embodiments set forth in the examples, but should be given the broadest interpretation consistent with the description as a whole.

1.-20. (canceled)

21. A tire scanning apparatus, the tire scanning apparatus comprising:
a body;
one or more tire support features attached to the body for supporting a tire in a substantially upright orientation for rotation substantially in place about a rolling axis of the tire; and
a plurality of outer sensors attached to the body to capture outer surface geometry data corresponding to an intersection of an imaging plane and an outer surface of a portion of the tire.

22. A tire scanning apparatus according to claim 21 comprising an inner sensor head moveably connected to the body, the inner sensor head positionable within a cavity defined by an inner surface of the tire to capture inner surface geometry data corresponding to an intersection of the imaging plane and an inner surface of the portion of the tire.

23. A tire scanning apparatus according to claim 21 wherein the plurality of outer sensors comprises one or more first outer sensors directed to a first outer sidewall surface of the tire and one or more second outer sensors directed to a second outer sidewall surface of the tire.

24. A tire scanning apparatus according to claim 23 wherein the plurality of outer sensors comprises one or more third outer sensors directed to an outer tread surface of the tire.

25. A tire scanning apparatus according to claim 21 wherein the plurality of outer sensors are arranged in pairs of outer sensors and each pair of outer sensors comprises a first sensor of the pair of outer sensors on a first side of the imaging plane and a second sensor of the pair of outer sensors on a second side of the imaging plane.

26. A tire scanning apparatus according to claim 21 wherein a combined field of view of the plurality of outer sensors captures the entirety of the intersection of the imaging plane with the outer surface of the portion of the tire.

27. A tire scanning apparatus according to claim 22 wherein a combined field of view of the plurality of inner sensors captures the entirety of the intersection of the imaging plane with the inner surface of the portion of the tire.

28. A tire scanning apparatus according to claim 21 comprising one or more outer planar laser projectors oriented to project laser light substantially co-planar with the imaging plane.

29. A tire scanning apparatus according to claim 22 wherein the plurality of inner sensors comprises one or more first inner sensors directed to a first inner sidewall surface of the tire and one or more second inner sensors directed to a second inner sidewall surface of the tire.

30. A tire scanning apparatus according to claim 29 wherein the plurality of inner sensors comprises one or more third inner sensors directed to an inner tread surface of the tire.

31. A tire scanning apparatus according to claim 22 wherein:
the plurality of inner sensors comprises one or more first inner sensors directed to a first inner sidewall surface of the tire;
the plurality of inner sensors comprises one or more second inner sensors directed to a second inner sidewall surface of the tire; and
the one or more first inner sensors are located on a first side of the imaging plane and the one or more second inner sensors are located on a second side of the imaging plane.

32. A tire scanning apparatus according to claim 22 wherein:
the plurality of inner sensors comprises one or more third inner sensors directed to an inner tread surface of the tire; and
one of the one or more third inner sensors is located on a first side of the imaging plane and another one of the one or more third inner sensors is located on a second side of the imaging plane.

33. A tire scanning apparatus according to claim 22 comprising one or more inner planar laser projectors arranged to project laser light substantially co-planar with the imaging plane.

34. A tire scanning apparatus according to claim 21 wherein the tire support features comprise two or more lower rollers for rotatably supporting the tire in the substantially upright orientation.

35. A tire scanning apparatus according to claim 21 wherein the tire support features comprise a bias roller biasable down against the tire to keep the tire substantially in place.

36. A tire scanning apparatus according to claim 35 wherein the bias roller comprises a plurality of annular rings threaded onto a rod such that the bias roller can accommodate inconsistencies in the shape of the tire.

37. A tire scanning apparatus according to claim 34 comprising a belt supported by the two lower rollers wherein the tire is rotatably supported in the substantially upright orientation on the belt.

38. A tire scanning apparatus according to claim 22 wherein the inner sensor head is retractable to allow for insertion and removal of the tire from the tire scanning apparatus.

39. A method of tire scanning, the method comprising:
supporting a tire in a substantially upright orientation for rotation substantially in place about a rolling axis of the tire;
capturing first outer surface geometry data corresponding to an intersection of an imaging plane and an outer surface of a first radial slice of the tire;
rotating the tire about the rolling axis of the tire;
capturing second outer surface geometry data corresponding to an intersection of the imaging plane and an outer surface of a second radial slice of the tire.

40. A method of tire scanning according to claim 39, the method further comprising:
positioning an inner sensor head within a cavity defined by an inner surface of the tire;
capturing first inner surface geometry data corresponding to an intersection of the imaging plane and an inner surface of the first radial slice of the tire; and
after rotating the tire about the rolling axis of the tire:
capturing second inner surface geometry data corresponding to an intersection of the imaging plane and an inner surface of the second radial slice of the tire.

41. A method according to claim 40 or any other claim herein wherein capturing the first outer surface geometry data and the first inner surface geometry data occurs substantially simultaneously and wherein capturing the second outer surface geometry data and the second inner surface geometry data occurs substantially simultaneously.

42. A method according to claim 40 comprising rotating the tire about the rolling axis of the tire continuously while capturing the first outer surface geometry data, the first inner surface geometry data, the second outer surface geometry data and the second inner surface geometry data.
